(19) United States
(12) Patent Application Publication
(10) Pub. No.: US 2024/0068933 A1
(43) Pub. Date: Feb. 29, 2024

(54) MICROFLUIDIC ROTOR DEVICE

(71) Applicant: ZOETIS SERVICES LLC, Parsippany, NJ (US)

(72) Inventors: Audie Hickey, Union City, CA (US); HEI KA TAM, San Ramon, CA (US)

(21) Appl. No.: 18/237,508

(22) Filed: Aug. 24, 2023

Related U.S. Application Data
(60) Provisional application No. 63/400,903, filed on Aug. 25, 2022.

(51) Int. Cl. G01N 21/03

(52) U.S. Cl. CPC G01N 21/03

(57) ABSTRACT

A microfluidic rotor for characterizing analytes in a fluid includes a plurality of cuvettes containing one or more selected reagent. The rotor further includes a plurality of cuvette marks. The rotor has a cuvette mark to cuvette ratio other than 1:1. For example, the ratio of the cuvette mark to the cuvette-receiving chamber may be, in certain instances, 1:4.

### CROSS REFERENCE TO RELATED APPLICATION

This application claims the benefit of U.S. Provisional Patent Application No. 63/400,903, filed Aug. 25, 2022, which is expressly incorporated herein by reference in its entirety.

### FIELD

The present disclosure relates to rotor devices, systems, and kits configured to characterize one or more analytes.

### BACKGROUND

This section provides background information related to the present disclosure which is not necessarily prior art.

Analysis of analytes, and in particular, analytes in fluids, is important in a variety of fields. For example, analysis of fluids from a subject may be used as a diagnostic tool to monitor health and diagnosis disease. Apparatuses (for example, analyzers) configured to characterize analytes in fluids are often configured to receive one or more rotors, each having a plurality of cuvettes containing one or more selected reagents. The analyzers include optical systems and photodetectors configured to monitor chemical reactions in the cuvettes. For example, the analyzers may be configured to spin the one or more rotors while the optical systems direct (or flash) light through the cuvettes on to the photodetector so as to produce output signals that are (directly or inversely) proportional to amounts of different products resulting from reactions between analytes and reagents. The rotor includes a plurality of cuvette (or location) marks that also reflect light omitted by the optical system. Detection of each cuvette mark signals the analyzer that another cuvette has passed and allows a controller to keep track of which cuvette of the plurality is being analyzed. Rotors often have a 1:1 cuvette mark to cuvette ratio, and analyzers use time-based calibrations to synchronize application of the light to selected cuvettes. It is desirable to increase the number of cuvettes that can be held by each rotor, for example, by reducing the number of cuvette marks. Changing the cuvette mark to cuvette ratio may, however, increase positional errors. Accordingly, it is desirable to develop position-based approaches that synchronize application of the light to selected cuvettes.

### SUMMARY

This section provides a general summary of the disclosure and is not a comprehensive disclosure of its full scope or all of its features.

In at least one example embodiment, the present disclosure provides a rotor for use in an apparatus for characterizing analytes in a fluid. The rotor may include a plurality of cuvette-receiving chambers and a plurality of cuvette marks. The cuvette-receiving chambers may be configured to receive a cuvette containing one or more selected reagent. The rotor may have a cuvette mark to cuvette-receiving chamber ratio other than 1:1.

In at least one example embodiment, the plurality of cuvette-receiving chambers may include one or more groups of cuvette-receiving chambers, where a single group of the one or more groups of cuvette-receiving chambers is disposed between consecutive cuvette marks of the plurality of cuvette marks, and an angular separation adjacent cuvette-receiving chambers defining each of the one or more groups of cuvette-receiving chambers may be about 6 degrees.

In at least one example embodiment, the rotor may include 12 cuvette marks and 48 cuvette-receiving chambers.

In at least one example embodiment, the rotor may have a cuvette mark to cuvette-receiving chamber ratio of 1:4.

In at least one example embodiment, the plurality of cuvette-receiving chambers may include one or more groups of cuvette-receiving chambers, where a single group of the one or more groups of cuvette-receiving chambers is disposed between consecutive cuvette marks of the plurality of cuvette marks, and an angular separation between adjacent cuvette-receiving chambers defining each of the one or more groups of cuvette-receiving chambers is about 7.5 degrees.

In at least one example embodiment, the rotor may include 6 cuvette marks and 42 cuvette-receiving chambers.

In at least one example embodiment, the rotor may have a cuvette mark to cuvette-receiving chamber ratio of 1:7.

In at least one example embodiment, the plurality of cuvette-receiving chambers may include one or more groups of cuvette-receiving chambers, where a single group of the one or more groups of cuvette-receiving chambers is disposed between consecutive cuvette marks of the plurality of cuvette marks, and an angular separation between adjacent cuvette-receiving chambers defining each of the one or more groups of cuvette-receiving chambers may be about 10 degrees.

In at least one example embodiment, the rotor may include 4 cuvette marks and 32 cuvette-receiving chambers.

In at least one example embodiment, the rotor may have a cuvette mark to cuvette-receiving chamber ratio of 1:8.

In at least one example embodiment, each of the plurality of cuvette marks may have the same dimensions.

In at least one example embodiment, a first mark of the plurality of cuvette marks may have a first width, and the remaining marks of the plurality of cuvette marks may have a second width, where the first width is larger than the second width.

In at least one example embodiment, the remaining marks may each have the same dimensions.

In at least one example embodiment, the present disclosure provides a rotor for use in an apparatus for characterizing analytes in a fluid. The rotor may include a plurality of cuvette-receiving chambers and a plurality of cuvette marks. Each of the cuvette-receiving chambers may be configured to receive a cuvette containing one or more selected reagent. The rotor may have a cuvette mark to cuvette-receiving chamber ratio greater than or equal to about 1:8 to less than or equal to about 1:1.

In at least one example embodiment, the plurality of cuvette-receiving chambers may include one or more groups of cuvette-receiving chambers, where a single group of the one or more groups of cuvette-receiving chambers is disposed between consecutive cuvette marks of the plurality of cuvette marks, and an angular separation between adjacent cuvette-receiving chambers defining each of the one or more groups of cuvette-receiving chambers may be greater than or equal to about 5 degrees to less than or equal to about 10 degrees.

In at least one example embodiment, the rotor may include greater than or equal to about 4 to less than or equal to about 30 cuvette marks and greater than or equal to about 30 to less than or equal to about 60 cuvette-receiving chambers.

In at least one example embodiment, a first mark of the plurality of cuvette marks may have a first width, and the remaining marks of the plurality of cuvette marks may have a second width, where the first width is larger than the second width.

In at least one example embodiment, the remaining marks may each have the same dimensions.

In at least one example embodiment, the present disclosure provides a rotor for use in an apparatus for characterizing analytes in a fluid. The rotor may include one or more groups of cuvette-receiving chambers and a plurality of cuvette marks. Each of the cuvette-receiving chambers defining the one or more groups of cuvette-receiving chambers may be configured to receive a cuvette containing one or more selected reagent. An angular separation between adjacent cuvette-receiving chambers defining each of the one or more groups of cuvette-receiving chambers may be greater than or equal to about 6 degrees to less than or equal to about 15 degrees.

In at least one example embodiment, a first mark of the plurality of cuvette marks may have a first width, and the remaining marks of the plurality of cuvette marks may have a second width, where the first width is larger than the second width.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is an illustration of an exemplary apparatus configured to characterize analytes carried by cuvette in accordance with various aspects of the present disclosure;

FIG. 2 is a top-down illustration of an exemplary rotor, for example for use with the apparatus illustrated in FIG. 1, including a plurality of cuvette marks and a plurality of cuvette-receiving chambers, where a cuvette mark to a cuvette-receiving chamber ratio is 1:4 in accordance with various aspects of the present disclosure;

FIG. 3 is a top-down illustration of an exemplary rotor, for example for use with the apparatus illustrated in FIG. 1, including a plurality of cuvette marks and a plurality of cuvette-receiving chambers, where a cuvette mark to a cuvette-receiving chamber ratio is 1:7 in accordance with various aspects of the present disclosure;

FIG. 4 is a top-down illustration of an exemplary rotor, for example for use with the apparatus illustrated in FIG. 1, including a plurality of cuvette marks and a plurality of cuvette-receiving chambers, where a cuvette mark to a cuvette-receiving chamber ratio is 1:8 in accordance with various aspects of the present disclosure; and

FIG. 5 is a top-down illustration of an exemplary rotor, for example for use with the apparatus illustrated in FIG. 1, including a plurality of cuvette marks and a plurality of cuvette-receiving chambers, where at least one of the cuvette marks is an index mark in accordance with various aspects of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

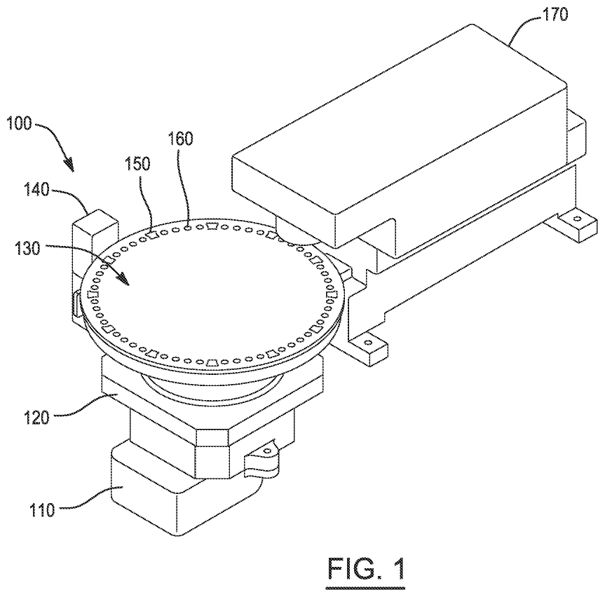

The present disclosure provides an apparatus 100 for characterizing analytes in a fluid and/or to measure or control system function. As illustrated in FIG. 1, the apparatus 100 may be configured to receive a microfluidic rotor 130 including, as further detailed below, a plurality of cuvette-receiving chambers 160 configured to receive cuvettes (not shown). The analyzer 100 may include a first photodetector 140 that is configured to monitor the presence of cuvette marks 150 on the microfluidic rotor 130. The analyzer 100 may also include an optical system 170 that monitors chemical reactions in the cuvettes disposed in the microfluidic rotor 130. For example, a motor 120 may be configured to spin the rotor 130 while the optical system 170 directs light through one or more of the plurality of cuvettes and onto a second photodetector (not shown), producing output signals that are (directly or inversely) proportional to amounts of different products resulting from reactions in the cuvettes. In at least one example embodiment, the second photodetector may be located between the microfluidic rotor 130 and the motor 120. In at least one example embodiment, the second photodetector may part of the optical system 170.

The microfluidic rotor 130 includes a plurality of cuvette (or location) marks 150 disposed (or formed) on (or in) the surface of the rotor 130. The cuvette marks 150 reflect light that may be omitted by a phototransmitter, and the reflected light may be received by a photodetector, where detection of each cuvette mark 150 signals to the analyzer 100 that another group of the plurality of cuvette-receiving chambers 160 has passed and allows a controller (not shown) disposed within (or in communication with) the analyzer 100 to keep track of which cuvette of the plurality is being analyzed. The phototransmitter and photodetector may together define the first photodetector 140.

Different ratios of cuvette marks 150 to cuvettes are envisioned. By increasing the number of measurement sites (i.e., chambers 160) to cuvette mark 150, space is created on the circumference of the microfluidic rotor 130 allowing for more measurement sites. In at least one example embodiment, the microfluidic rotor 30 may have a cuvette mark 150 to cuvette-receiving chamber 160 ratio of greater than or equal to about 1:8 to less than or equal to about 1:1, and in certain aspects, optionally greater than or equal to about 1:8 to less than or equal to about 1:4. In at least one example embodiment, the plurality of cuvette-receiving chambers 160 may include one or more groups of cuvette-receiving chambers 160 and an angular separation between adjacent cuvette-receiving chambers 160 defining each of the one or more groups of cuvette-receiving chambers 160 may be greater than or equal to about 5 degrees to less than or equal to about 15 degrees, optionally greater than or equal to about 6 degrees to less than or equal to about 15 degrees, and in certain aspects, optionally greater than or equal to about 5 degrees to less than or equal to about 10 degrees. In at least one example embodiment, the angular separation between cuvette-receiving chambers 160 and agent cuvette marks 150 may be similarly greater than or equal to about 5 degrees to less than or equal to about 15 degrees, optionally greater than or equal to about 6 degrees to less than or equal to about 15 degrees, and in certain aspects, optionally greater than or equal to about 5 degrees to less than or equal to about 10 degrees. In at least one example embodiment, the microfluidic rotor 30 may include greater than or equal to about 4 to less than or equal to about 30, and in certain aspects, optionally greater than or equal to about 4 to less than or equal to about 12, cuvette marks 150. In at least one example embodiment, the microfluidic rotor 30 may include greater than or equal to about 30 to less than or equal to about 60, and in certain aspects, optionally greater than or equal to about 32 to less than or equal to about 48, cuvette-receiving chambers 160.

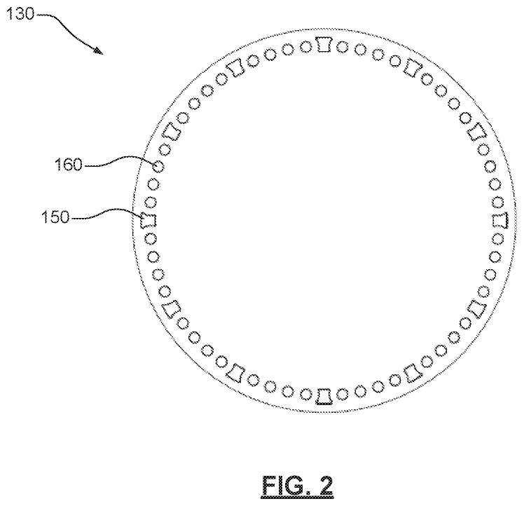

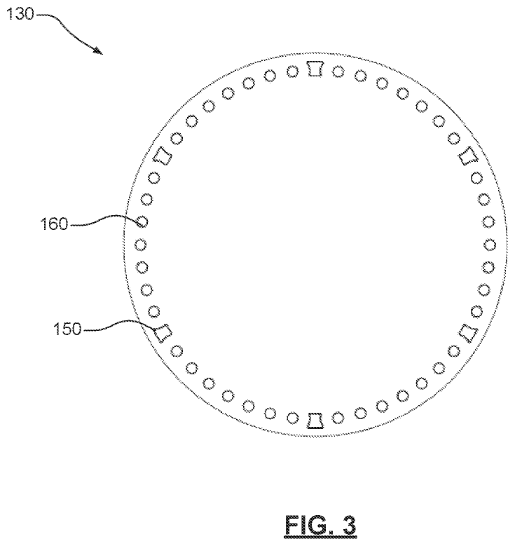

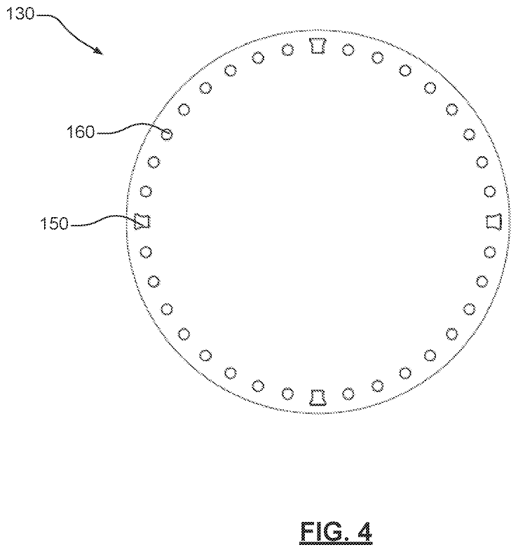

As illustrated in FIG. 2, in at least one example embodiment, the microfluidic rotor 130 may include twelve cuvette marks 150 and forty-eight cuvette-receiving chambers 160 (i.e., a cuvette mark 150 to cuvette-receiving chamber 160 ratio of 1:4), where there exists an angular separation between cuvette marks 150 and adjacent cuvette-receiving chambers 160 of about six degrees. As illustrated in FIG. 3, in at least one example embodiment, the microfluidic rotor 130 may include six cuvette marks 150 and forty-two cuvette-receiving chambers 160 (i.e., a cuvette mark 150 to cuvette chamber 160 ratio of 1:7), where there exists an angular separation between cuvette marks 150 and cuvette-receiving chambers 160 of about seven and a half degrees. As illustrated in FIG. 4, in at least one example embodiment, the microfluidic rotor 130 may include four cuvette marks 150 and thirty-two cuvette-receiving chamber 160 (i.e., a cuvette mark 150 to cuvette chamber ratio 160 of 1:8), where there exists an angular separation between cuvette marks 150 and cuvette-receiving chambers 160 of about ten degrees. In at least one example embodiment, the cuvette marks 150 may have the same shape and configuration and may be symmetrically disposed around the circumference of the microfluidic rotor 130.

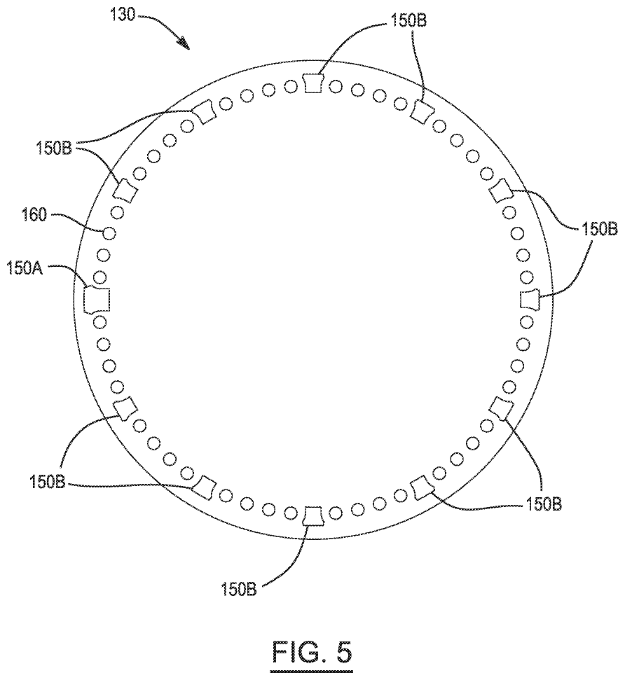

In at least one example embodiment, as illustrated in FIG. 5, the microfluidic rotor 130 may include one cuvette mark 150A that has a larger size than the other cuvette marks 150B, such that the one cuvette mark 150A can serve as an index mark. The other cuvette marks 150B may have the same or different shapes and configurations and may be symmetrically disposed around the circumference of the rotor 130. In at least one example embodiment, the index mark 150A may be wider than the other cuvette marks 150B. For example, the index mark 150A may be twice as wide as the cuvette marks 150B. In at least one example embodiment, the microfluidic rotor 130 may include one index mark 150A, eleven cuvette marks 150B, and forty-eight cuvette chambers 160 (i.e., a cuvette mark 150 to cuvette chamber 160 ratio of 1:4), where there exists an angular separation between cuvette marks 150A, 150B of about thirty degrees. In each instance, the index mark 150A assigns a zero position to the microfluidic rotor 130 that allows, for example, the assignment of relative positions of each of the remaining cuvette marks 150B and as a result the relative positions of each cuvette-receiving chamber 160.

In each instance, increasing the distance between consecutive cuvette marks 150, 150A, 150B can causes positioning errors. In various aspects, the present disclosure provides a high resolution (e.g., 5,000 line (20,000 quadrature counts) per revolution) motor position encoder 110. The motor precision encoder 110 may be defined on or mounted to a (hollow) shaft connecting the microfluidic rotor 130 and the motor 120. In at least one example embodiment, the motor position encoder 110 may be an off-the-shelf component that includes a disk mounted to a precision machined hub and an encoder module. The center of each cuvette mark 150, 150A, 150B may be mapped onto the motor position encoder 110. More particularly, the center of each cuvette mark 150, 150A, 150B may be mapped onto the disk as mounted to the precision machined hub. The encoder 110 allows thus allows for accurate division of an entire rotation of the motor into smaller segments. A motor position encoder 110 having 20,000 quadrature counts may allow for determination of rotor position to within about 0.018 degrees, that is 1/20,000 of 360 degrees. For example, when four cuvette-receiving chambers 160 are disposed between cuvette marks 150, 150A, 150B, the motor position encoder 100 has 20,000 counts, and the location of the consecutive cuvette marks 150, 150A, 150B are determined to be 1235 and 2900, the location of the intervening four cuvette-receiving chambers 160 will have locations of 1568, 1901, 2234, and 2567, respectively (assuming equal spacing between each adjacent cuvette mark 150, 150A, 150B and cuvette-receiving chamber 160).

In at least one example embodiment, the motor 120 may be operated in a position mode, where the motor 120 is configured to follow the shortest path to each cuvette chamber 160 of the plurality, and the plurality of cuvette marks can be used as a data set to build a model that defines a relationship between the as-measured marks and known locations of the cuvette marks 150, 150A, 150B of the selected microfluidic rotor 130 (such as, illustrated in FIGS. 2-5). Building the model may include, first, determining an error (or difference) between measured cuvette marks and the predicted cuvette marks. For example, based on the motor position encoder 110 values for two consecutive cuvette marks 150, 150A, 150B and the relative motor speeds at those cuvette marks it may be possible to create a model to determine the locations of the cuvettes-receiving chambers 160 between the two cuvette marks 150, 150A, 150B. If the motor speeds at both cuvette marks 150, 150A, 150B are identical than the locations of the intervening cuvette-receiving chambers 160 may be a linear interpolation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A rotor for use in an apparatus for characterizing analytes in a fluid, the rotor comprising
a plurality of cuvette-receiving chambers each configured to receive a cuvette containing one or more selected reagent; and
a plurality of cuvette marks, the rotor having a cuvette mark to cuvette-receiving chamber ratio other than 1:1.

2. The rotor of claim 1, wherein the plurality of cuvette-receiving chambers includes one or more groups of cuvette-receiving chambers, wherein a single group of the one or more groups of cuvette-receiving chambers is disposed between consecutive cuvette marks of the plurality of cuvette marks, and wherein an angular separation adjacent cuvette-receiving chambers defining each of the one or more groups of cuvette-receiving chambers is about 6 degrees.

3. The rotor of claim 2, wherein the rotor includes 12 cuvette marks and 48 cuvette-receiving chambers.

4. The rotor of claim 2, wherein the rotor has a cuvette mark to cuvette-receiving chamber ratio of 1:4.

5. The rotor of claim 1, wherein the plurality of cuvette-receiving chambers includes one or more groups of cuvette-receiving chambers, wherein a single group of the one or more groups of cuvette-receiving chambers is disposed between consecutive cuvette marks of the plurality of cuvette marks, and wherein an angular separation between adjacent cuvette-receiving chambers defining each of the one or more groups of cuvette-receiving chambers is about 7.5 degrees.

6. The rotor of claim 5, wherein the rotor includes 6 cuvette marks and 42 cuvette-receiving chambers.

7. The rotor of claim 5, wherein the rotor has a cuvette mark to cuvette-receiving chamber ratio of 1:7.

8. The rotor of claim 1, wherein the plurality of cuvette-receiving chambers includes one or more groups of cuvette-receiving chambers, wherein a single group of the one or more groups of cuvette-receiving chambers is disposed between consecutive cuvette marks of the plurality of cuvette marks, and wherein an angular separation between adjacent cuvette-receiving chambers defining each of the one or more groups of cuvette-receiving chambers is about 10 degrees.

9. The rotor of claim 8, wherein the rotor includes 4 cuvette marks and 32 cuvette-receiving chambers.

10. The rotor of claim 8, wherein the rotor has a cuvette mark to cuvette-receiving chamber ratio of 1:8.

11. The rotor of claim 1, wherein each of the plurality of cuvette marks have the same dimensions.

12. The rotor of claim 1, wherein a first mark of the plurality of cuvette marks has a first width, and the remaining marks of the plurality of cuvette marks have a second width, the first width being larger than the second width.

13. The rotor of claim 12, wherein the remaining marks each have the same dimensions.

14. A rotor for use in an apparatus for characterizing analytes in a fluid, the rotor comprising
a plurality of cuvette-receiving chambers each configured to receive a cuvette containing one or more selected reagent; and
a plurality of cuvette marks, the rotor having a cuvette mark to cuvette-receiving chamber ratio greater than or equal to about 1:8 to less than or equal to about 1:1.

15. The rotor of claim 14, wherein the plurality of cuvette-receiving chambers includes one or more groups of cuvette-receiving chambers, wherein a single group of the one or more groups of cuvette-receiving chambers is disposed between consecutive cuvette marks of the plurality of cuvette marks, and wherein an angular separation between adjacent cuvette-receiving chambers defining each of the one or more groups of cuvette-receiving chambers is greater than or equal to about 5 degrees to less than or equal to about 10 degrees.

16. The rotor of claim 14, wherein the rotor includes greater than or equal to about 4 to less than or equal to about 30 cuvette marks and greater than or equal to about 30 to less than or equal to about 60 cuvette-receiving chambers.

17. The rotor of claim 14, wherein a first mark of the plurality of cuvette marks has a first width, and the remaining marks of the plurality of cuvette marks have a second width, the first width being larger than the second width.

18. The rotor of claim 17, wherein the remaining marks each have the same dimensions.

19. A rotor for use in an apparatus for characterizing analytes in a fluid, the rotor comprising:
one or more groups of cuvette-receiving chambers, each of the cuvette-receiving chambers defining the one or more groups of cuvette-receiving chambers configured to receive a cuvette containing one or more selected reagent; and
a plurality of cuvette marks, an angular separation between adjacent cuvette-receiving chambers defining each of the one or more groups of cuvette-receiving chambers being greater than or equal to about 6 degrees to less than or equal to about 15 degrees.

20. The rotor of claim 19, wherein a first mark of the plurality of cuvette marks has a first width, and the remaining marks of the plurality of cuvette marks have a second width, the first width being larger than the second width.
